(19) United States
(12) Patent Application Publication
(10) Pub. No.: US 2008/0191006 A1
(43) Pub. Date: Aug. 14, 2008

(54) ATM With Award Feature

(75) Inventor: Cindy White, Hockessin, DE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/673,359

(22) Filed: Feb. 9, 2007

(51) Int. Cl. G07F 19/00

(52) U.S. Cl. 235/379

(57) ABSTRACT

An automatic teller machine (ATM) with award feature is disclosed. The ATN includes a user interface, a communications interface connected to an ATM network, and a processor. The communications interface is adapted to receive account information from an ATM card, receive input from the user, and present information to the user. The ATM receives account information from an ATM card associated with a user, authenticates the user for transactions with the ATM card, and completes a financial transaction between the user and a financial institution connected through the network adapter. The ATM may also present the user, through the user interface, with a game of chance, a reward program, coupons, a lottery, etc.

### CROSS-REFERENCES TO RELATED APPLICATIONS

This application expressly incorporates by reference U.S. patent application Ser. No. 10/225,410, filed on Aug. 20, 2002, entitled “Multi-Purpose Kiosk And Methods,” in its entirety for all purposes.

### BACKGROUND OF THE INVENTION

Automated Teller Machines (ATMs) are computerized telecommunications devices that provide users a secure method of performing financial transactions in a public space without the need for a human clerk or bank teller. Users can access their bank accounts in order to make cash withdrawals (or credit card cash advances) and check their account balances. Many ATMs also allow people to deposit cash or checks, transfer money between their bank accounts, pay bills, or purchase goods and services.

Transactions completed at an ATM generate revenue for ATM and/or ATM network operators. Increased profits for the operators will result if ATM use increases. Accordingly, it is desirable to operators to encourage users to use ATMs.

### BRIEF SUMMARY OF THE INVENTION

In one embodiment of the invention the present disclosure provides an ATM. The ATM may include a user interface, a communication interface connected to an ATM network, and a processor. The user interface may be adapted to receive account information from an ATM card, receive input from the user, and present information to the user.

The processor may include instructions to receive account information from an ATM card associated with a user, authenticate the user for transactions with the ATM card, complete a financial transaction between the user and a financial institution connected through the network adapter, and present the user with a game of chance through the communications interface. The game of chance may be a lottery and the processor includes instructions to enter the user into a lottery and assign a lottery number to the account associated with the ATM card. The processor also include instructions to ask the user to select a lottery number from a pool of lottery numbers or the processor may select the lottery number. The ATM may also include memory to store lottery numbers and account numbers together in a memory location.

In another embodiment the ATM processor may also include instructions to present a listing of one or more coupons to the user and the user selects one or more coupons from the listing of one or more coupons. The ATM may also associate the coupons with the AM card such that the coupon is applied when a specific transaction is made with the ATM card. The coupon may only be applied a specific locations and for specific products or services. The ATM may include a printer and the coupons may be printed on paper by the printer.

In another embodiment the ATM processor may also include instructions to reward the user according to a reward program. The processor may also include instructions to determine which reward program is associated with the ATM card. The processor may include instructions to look up a reward program associated with an ATM card. The processor may include instructions to place funds within the account associated with the ATM card according to the reward program. The reward program may include a travel reward, money, and/or points for a shopping program.

In another embodiment an ATM processor may include instructions to query the user for a wager amount in a game and instructions to play the game. The instructions to play the game may include the following logic: if the user loses the wager, instructions to remove the wager amount from the account associated with the ATM card; and if the user wins the wager, instructions to place the wager amount in the account associated with the ATM card. The game may include electronic blackjack, electronic over-under game, electronic dice, electronic craps, and/or sports betting.

In one embodiment of the invention the present disclosure provides a method for providing a lottery feature to a user at an ATM. In a first step the ATM receives an ATM card from a user and authenticates the user for transactions with the ATM card. A financial transaction may be completed between the user and a financial institution connected through a network adapter. The system may querying the user to select a lottery number from a pool of lottery numbers, and the user selects a first lottery number through a user interface. The system then assigns the first lottery number to the card.

In one embodiment of the invention the present disclosure provides a method for providing coupons to a user at an ATM. In a first step the ATM receives an ATM card from a user and authenticates the user for transactions with the ATM card. A financial transaction may be completed between the user and a financial institution connected through a network adapter. In a second step the user is presented with a listing of one or more discount coupons and the system receives a selection from the user from the listing of one or more discount coupons.

In another embodiment of the invention the present disclosure provides a method for providing rewards to a user at an ATM. In a first step the ATM receives an ATM card from a user and authenticates the user for transactions with the ATM card. A financial transaction may be completed between the user and a financial institution connected through a network adapter. In a second step the user is rewarded according to a reward program.

In yet another embodiment of the invention the present disclosure provides a method for providing a game to a user at an ATM. In a first step the ATM receives an ATM card from a user and authenticates the user for transactions with the ATM card. A financial transaction may be completed between the user and a financial institution connected through a network adapter. In a first step the system queries the user for a wager amount in a game and then plays the game. If the user loses the wager, the system removes the wager amount from the account associated with the ATM card. If the user wins the wager, the system places the wager amount in the account associated with the ATM card.

### BRIEF DESCRIPTION OF THE DRAWINGS

FIG. 1 shows an ATM system and network for providing awards to an ATM user according to one embodiment of the invention.

FIG. 2 shows another ATM system and network for providing awards to an ATM user according to one embodiment of the invention.

FIG. 3 shows an exemplary block diagram of an ATM that may be used to provide awards to a user according to one embodiment of the invention.

FIG. 4 shows a flowchart of an ATM gaming method according to one embodiment of the invention.

FIG. 5 shows a flowchart of an ATM lottery method according to one embodiment of the invention.

FIG. 6 shows a flowchart of an ATM lottery method according to one embodiment of the invention.

FIG. 7 shows a flowchart of an ATM discount coupon generation method according to one embodiment of the invention.

FIGS. 8A, 8B, 8C and 8D show an ATM user interface operating a lottery feature according to one embodiment of the invention.

FIGS. 9A, 9B, 9C, 9D, 9E, and 9F show an ATM user interface operating an over-under dice game according to one embodiment of the invention.

In the appended figures, similar components and/or features may have the same reference label. Where the reference label is used in the specification, the description is applicable to any one of the similar components having the same reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

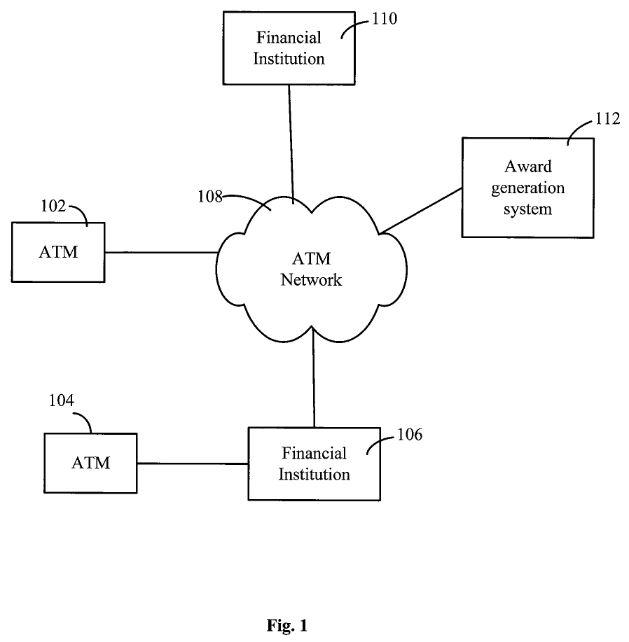

FIG. 1 illustrates a system that may be used to provide an award to an ATM user. The system includes ATMs 102, 104. While two ATMs are shown, any number of ATMs may be used. ATM 102 has a direct communication coupling to ATM network 108, while ATM 104 is communicatively coupled to ATM network 108 via a server at a financial institution 106 associated with the ATM 104. The ATM network 108 may be used to obtain information and authorization for an ATM 102, 104 to perform transactions requested by a user of the ATM 102, 104. Thus, ATM network 108 is able to communicate with a financial institution 110 associated with the ATM customer's financial account. By way of example, ATM network 108 may be a network, such as the NYCE® network, the Pulse® network, the STAR® network, the PLUS network, the Cirrus network, the Interac Network and the like. ATM network 108 may be used to verify a customer's authentication information (e.g., financial account and personal identification number (PIN)) and to provide authorization to an ATM 102, 104 to perform a transaction, such as a withdrawal of funds from a financial account or a transfer of funds from a first financial account to a second financial account.

ATM network 108 may also be used to obtain information on the customer's financial account, such as the account balance. The information and authorization may be provided directly to some ATMs 102 and may be provided to other ATMs 104 via a financial institution server 106. In some instances, the customer's financial account may be maintained at the financial institution 106 associated with the ATM 104. In these instances, financial institution 106 may provide the authorization and other information needed by the ATM 104 without using ATM network 108. It should be appreciated that the system may include many more ATMs 102, 104 and financial institutions 106, 110 than illustrated in FIG. 1. Further details on an ATM network is described in U.S. patent application Ser. No. 10/225,410, filed on Aug. 20, 2002, entitled “Multi-Purpose Kiosk And Methods,” which is incorporated herein in its entirety for all purposes.

ATM network 108 is communicatively coupled to an award generation system 112. The award generation system 112 may provide information on awards associated with a card, account, user, financial institution, etc. for users of an ATM. In some embodiments, the award generation system 112 may be used to provide award information for more than one ATM network 108 or for cards issued by more than one financial institution. Alternately, the award generation system 112 may be a component of ATM network 108. In some embodiments, the award generation system 112 may associate a card with a chosen lottery number or randomly generated lottery number; the award generation system may include a pool of available lottery numbers and may include a file linking ATM card numbers to lottery numbers. In other embodiments, the award generation system 112 may include a list of available discount coupons for specific locations. In yet other embodiments, the award generation system 112 may include over/under wager information. The award generation system may vary awards by location, account type, card type, over time, user enrollment, etc.

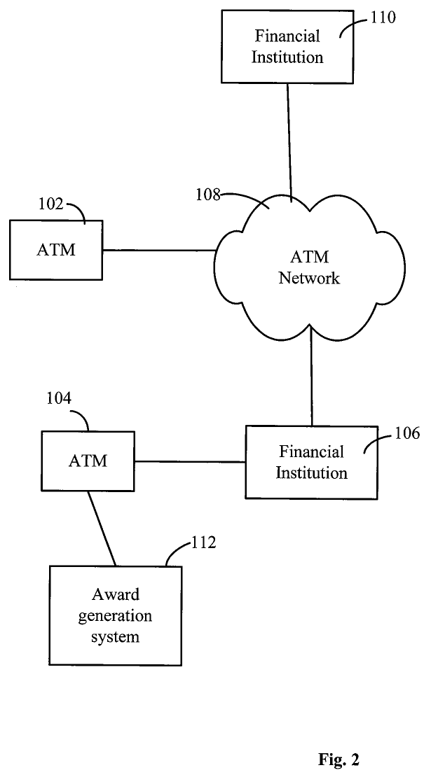

The award generation system 112, may be directly coupled to an ATM 104 as shown in FIG. 2 according to one embodiment of the invention. The award generation system may receive periodic updates to available awards and or awarding procedures through the ATM network. In other embodiments, the award generation system may be part of the ATM.

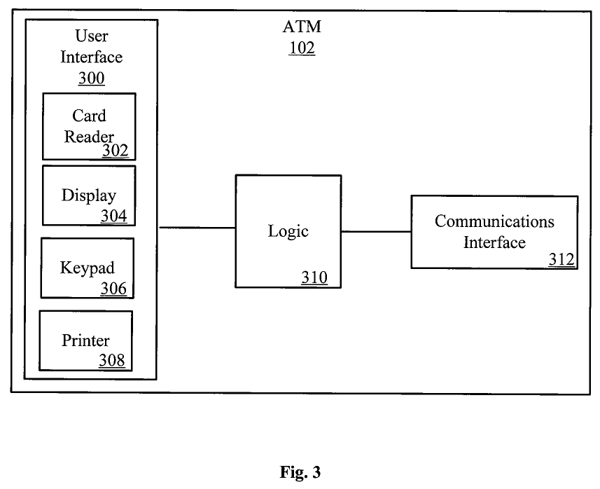

FIG. 3 illustrates an exemplary block diagram of an ATM 102 that may be used to provide awards to customers according to one embodiment of the invention. ATM 102 includes a user interface 300. User interface 300 may include multiple components, such as card reader 302, display 304, keypad 306, and printer 308. Card reader 302 may be used to receive a customer's ATM card and obtain a financial account number from the ATM card. Display 304 may be used to prompt the customer for responses needed to perform a transaction and to display information to the customer. Keypad 306 may be used to receive input from the customer, such as a personal identification number (PIN) associated with the customer's financial account, transaction selections, dollar amounts for transactions (if applicable), and other information related to a customer's transaction with the ATM. Additionally, as will be described in further detail below, display 304 may be used to display reward options for the user to select from. User interface 300 may also include a printer 308 that may be used to print a receipt of the transaction, and in some embodiments, the customer's remaining account balance. The printer 308 may also print coupons.

ATM 102 may further include logic 310 and communications interface 312. Logic 310 may be used to process a financial transaction requested by a customer of the ATM 102. By way of example, the financial transaction may be a withdrawal request, a balance transfer request, a deposit request, a purchase request (e.g., to purchase stamps, telephone calling cards, etc. using funds available in the customer's financial account), or other type of request that may be performed at an ATM. Logic 310 may receive information from user interface 300 and use communications interface 312 to communicate with ATM network 108. The logic may also perform reward functionality. The logic may electronically produce and perform games of chance; the logic may receive wagers and make payouts upon a successful wager. The logic may also determine whether a card and/or user participate in a rewards program.

Communications interface 312 is communicatively coupled to a server on ATM network 108. Logic 310 may use communications interface 312 to request authentication of a customer's financial account number received from user interface 300. In some embodiments, the authentication request transmitted to the ATM network 108 may also include a PIN which was received from the customer. Additionally, logic 310 may use communications interface 312 to request authorization of a transaction initiated by the customer. Other information used to perform a financial transaction may also be requested and received using communications interface 312.

Logic 310 may also be used to process at least a part of a financial transaction requested by the user and provide rewards to the user. Logic 310 may also prompt the customer to select whether the user wishes to participate in a lottery. If the user elects to participate, logic 310 may use the communications interface to obtain a lottery number from the award generation system 112. The lottery number may be communicated via ATM network 108, and displayed to the user. In an alternate embodiment, the award information may be stored locally at ATM 102, for example, discount coupon information. Logic 310 may use award information for a game, a lottery, to apply award points and/or provide discount coupons.

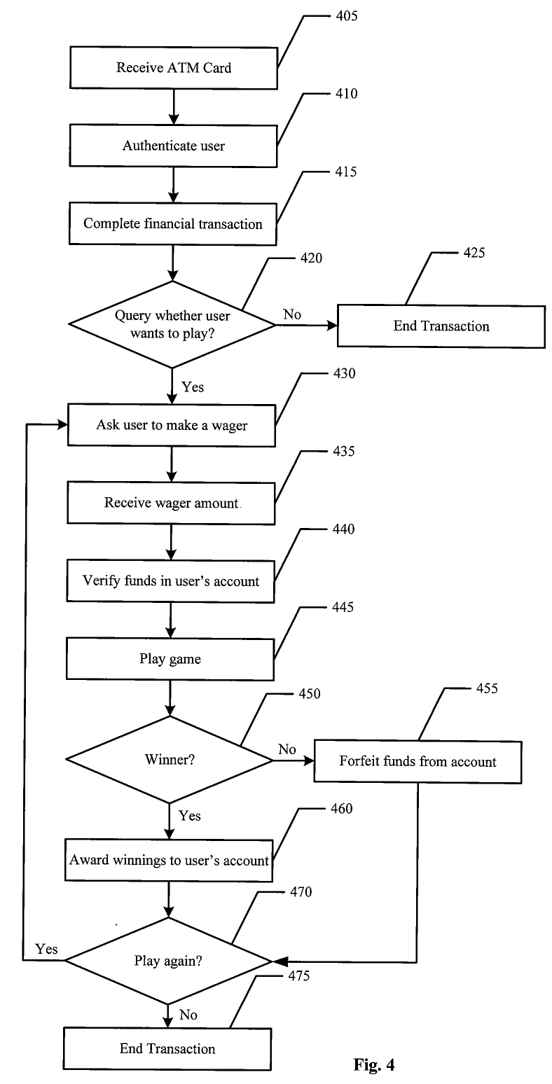

FIG. 4 shows a flowchart of an ATM system with a game system according to one embodiment of the invention. An ATM card is received from the user through the card reader 202 at block 405. Other account reading devices may be used to associate a user with a specific account, and other types of account representation devices may be used such as an RFID fob or smart card. Various card types may be used, for example, a bank card, an ATM card, a credit card, and/or a stored value card may be used. The user is authenticated 410. Authentication may require input from the user and/or communication through the ATM network 108 to a financial institution 110. Upon authentication, a financial transaction between the user and a financial institution 110 may occur. Upon completion of the transaction 415, the user is asked if they wish to play a game 420. If the user declines, the transaction is completed, 425. Otherwise, if the user accepts, the user is asked to make a wager 430.

The user may place the wager on any type of legal gambling. For example, an electronic card game may be played where the user bets on the outcome of a hand of blackjack or poker. In other embodiments, electronic dice games may be played. The user is asked to wager on the outcome of a roll of electronic dice, for example, an over-under wager. For example, with two dice, the user may be asked to wager whether the roll of the dice will result with a number that is over or under seven. An electronic coin toss may also be used where the user places a wager on the outcome of a coin toss. An electronic roulette wheel may also be used and the user is asked to wager on a color or a number. In other embodiments an electronic slot game may be presented to the user through the user interface. Any gambling used on the ATM must meet the requirements of federal, state and/or local laws or the appropriate foreign law depending on the jurisdiction within which the ATM is located.

Once the wager is received 435, the system confirms that the funds wagered are available 440. The game is then played 445. If the user loses 450, funds in the amount of the wager are removed from the user's account 455. If the user wins 450, funds in the amount of the wager are placed in the user's account 460. After playing, the user is asked if they wish to play again 470. If they wish to play again, the system starts over by asking the user to make a wager 430. If the user does not wish to play again, the transaction ends 475.

For example, a user completes a transaction at an ATM. The ATM then asks if the user wishes to play an over-under dice game. The user selects yes, and they are queried for a wager amount and whether they wish to place their wager over or under seven on a dice roll. The user wagers $10 and selects over. The system then confirms that $10 is in their account. The dice are electronically rolled on the screen and the dice show 4. The user loses, and $10 is removed from their account. The user may play again whereupon they again wager $10 and select over. The dice are rolled and produce 11. The user wins and are awarded $10. In other embodiments, the $10 is removed from the account once the wager is made, if the user wins, then $20 is placed into the account.

In another embodiment, the system may ask the user to wager on a future event. For example, the user may wager on the outcome of a sporting event. In some ATMs the user's card will then be returned. Accordingly, after the user's wager is received 435 and funds are verified 440; the transaction may be suspended until the future event occurs. Once the future event occurs, the system determines if the user is a winner and awards funds to user's account according to the wager or if the user loses the system pulls funds from the user's account according to the wager. In some embodiments, after verification of funds in the user's account, the funds are withdrawn and held in escrow drawn until the game is played.

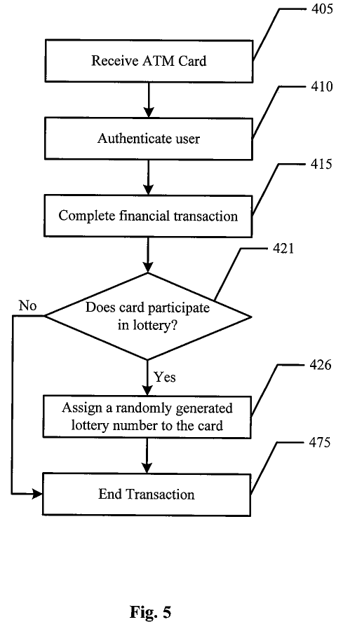

FIG. 5 shows a flowchart of an ATM system with a lottery system according to another embodiment of the invention. ATM account information is received from the user's ATM card through the user interface 200 at block 405. The user is authenticated 410. A financial transaction between the user and a financial institution 110 occurs. Upon completion of the financial transaction 415, the system determines whether the card participates in a lottery program 421. The issuer of ATM cards, the financial institution related to the card, or a store hosting the ATM may provide reward programs for ATM users, such as a lottery for ATM users. A user may need to register their cards for the lottery program. Registration may occur automatically when the card is used or when an account is established. Registration may also occur online or over the telephone.

If the card does not participate in the lottery, then the transaction ends 475. If the card does participate in the lottery, then a randomly generated lottery number is assigned to the card 426 and the transaction ends 475. The account number and lottery number are then stored together. A printed receipt with the lottery number will also be produced. At a later time, the operator of the lottery selects the winner by randomly drawing a lottery number. The draw may occur only with the lottery numbers used or may occur with all available lottery numbers whether used or not. The account associated with the winner of the lottery is credited with the lottery winnings.

A user may also enter the lottery once for each financial transaction performed at the ATM. Multiple transactions at the same ATM may result in multiple entries into the lottery. In other embodiments, users purchase lottery numbers or tickets through the ATM.

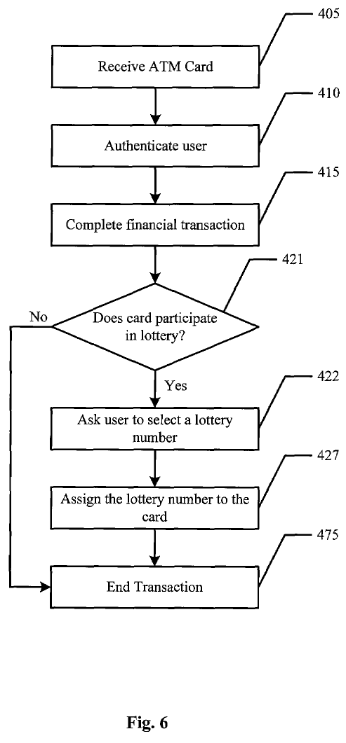

FIG. 6 shows a flowchart of an ATM system with a lottery system according to another embodiment of the invention. This embodiment is similar to the embodiment discussed in relation to FIG. 5. In this embodiment, the user is allowed to select a lottery number 422. The user-selected lottery number is then assigned to the card 427. Accordingly, multiple users may be assigned the same card number, potentially resulting in shared winnings between users that both selected the winning lottery number.

FIG. 7 shows a flowchart of an ATM system with a discount coupon generation system according to another embodiment of the invention. An ATM card is received 405, authenticated 410 and a financial transaction is completed 415. Upon completion 415, the ATM determines whether the card is registered for discount coupon distribution 620. The ATM may have to query a financial institution or a merchant associated with the ATM over the ATM network to determine if the card is registered for discount coupon distribution. If the card is not registered, the transaction ends 475. Otherwise, a listing of discount coupons is presented to the user 625 through the user interface 300. The user is asked to select a discount coupon or coupons 630. The selected discount coupon or discount coupons are then printed 635 and the transaction ends 475.

The discount coupons may be associated with a merchant hosting the ATM. For example, an ATM may be located within a grocery store. The discount coupons presented to the user at the ATM may be for grocery items. In other embodiments, rather than printing discount coupons, discount coupons are tied to the ATM card used at the ATM. The coupons selected by the user (or default coupons) are transmitted to a merchant computer system. When the user makes a purchase of a specific item at a participating merchant (for example, the grocery store where the ATM is located) with the ATM card, discounts are automatically applied to the item by the merchant's computer system at checkout.

Other rewards may be issued in association with a completed ATM transaction. For example, the user may register to receive a number of travel rewards, such as sky miles, for each completed transaction. Purchase points may be rewarded for each transaction. These points may be saved and exchanged for goods and services as specified by the operator of the system. For example, twenty points may be earned for each transaction. Once a user has reached some threshold, for example 500 points, they may exchange the points for online music, a gift card, or other merchandise.

Rewards may be issued based on a sliding scale. Operators of an ATM or ATM network may wish to encourage users to use seldom used ATM features or new ATM features. Accordingly, the operators may provide greater rewards to users that use such features. Operators may increase the odds in favor of the user in a gambling reward or provide free games. Operators may also provide a sliding scale of rewards based on the monetary amount in financial transaction. A sliding scale may also be implemented based on other factors.

In one embodiment, when rewards are based on gambling, a limited number of wagers or a limit on the wager amount may be implemented. In other embodiments, the wager amount may be fixed, for example, at one dollar.

In another embodiment, ATM operators or ATM network operators may charge fees associated with reward transactions. The fees may be paid by third parties or by the user as agreed to in a user agreement.

Another embodiment of the invention provides for an ATM that performs games while the ATM is processing transactions. For example, while a user is waiting for a transaction to occur, the ATM may provide a game of chance for entertainment purposes. In one embodiment, if the user wins, the ATM may waive a transaction fee or provide a nominal compensation. In other embodiments, the use may make wagers during these times. In other embodiments, the ATM may present a question for the user to answer and a reward may be given for a correct response.

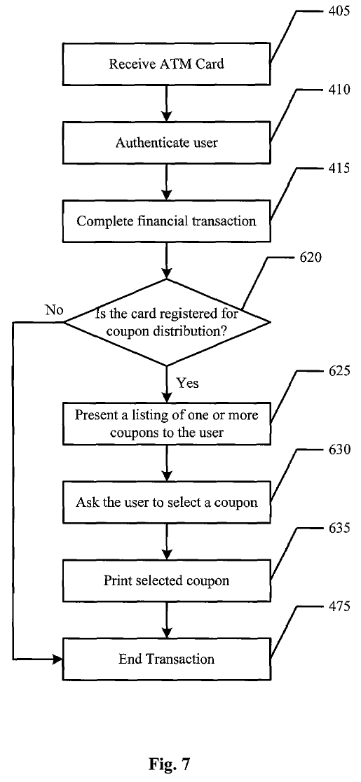

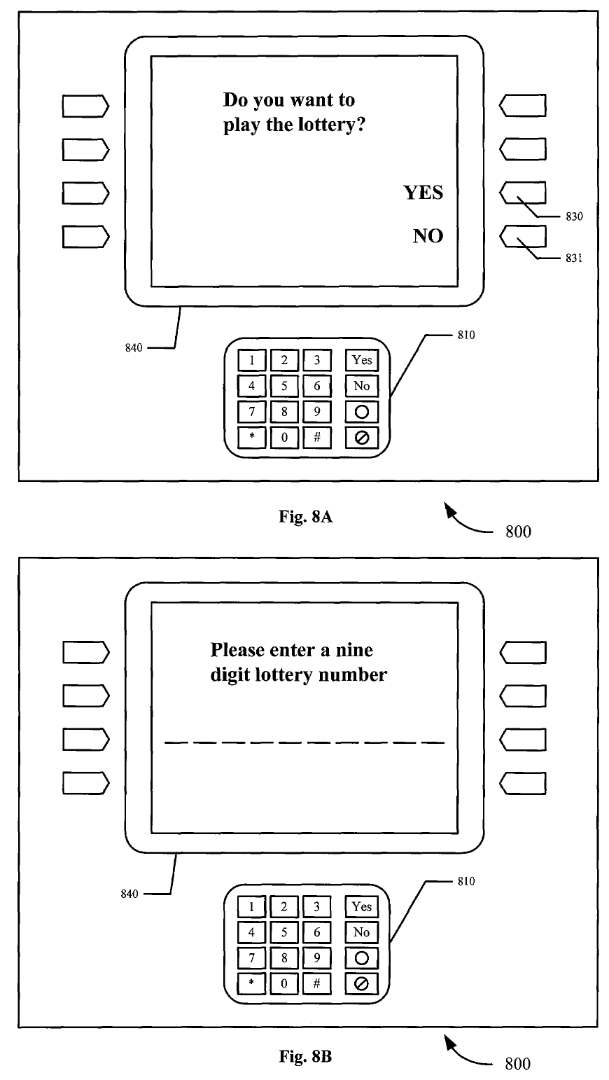

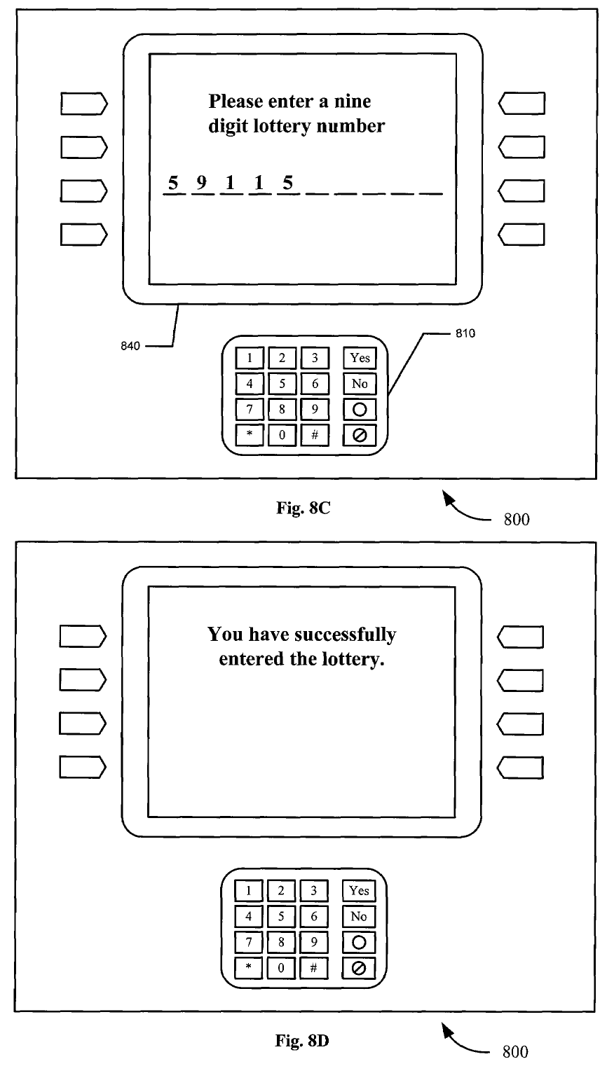

FIG. 8A shows an exemplary ATM interface 800 according to one embodiment of the invention. The interface includes a keypad 810 and a variety of configurable input buttons 830, 831 and a screen 840. At the conclusion of an ATM transaction, the user is presented with a question on the screen 840 asking “Do you want to play the lottery?”. In some embodiments ATM cards must be registered for the lottery feature. Minors with ATM cards may be excluded from the lottery functionality. The user may then make a selection either “YES” or “NO” by selecting the appropriate configurable button 830, 831.

If the user elects to play the lottery as requested in FIG. 8A, the user may be asked, through the screen 840 to enter a lottery number as shown in FIG. 8B. In this example, the user is asked to enter a nine digit lottery number. The user may then enter a lottery number using the keypad 810. FIG. 8C shows the screen 840 with a portion of the user-selected lottery number entered from the keypad 810. In other embodiments, a random lottery number may be generated. Finally, in FIG. 8D, the user is informed that they have entered the lottery. The user may then be presented with a printed receipt with their lottery number. At a later date, a drawing may be held to select a winning lottery number and the user associated with the number is informed.

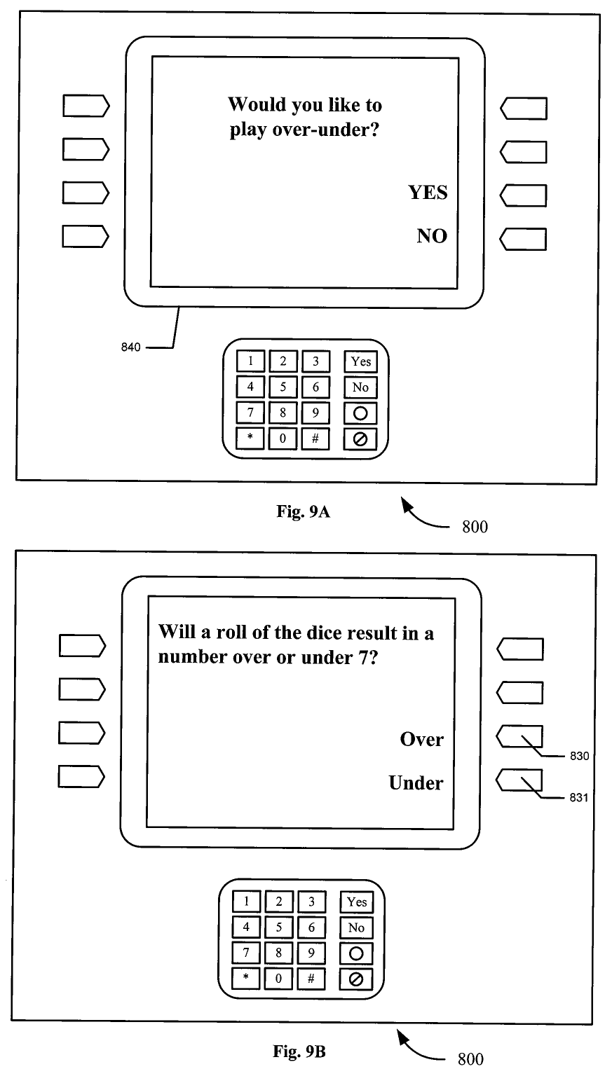

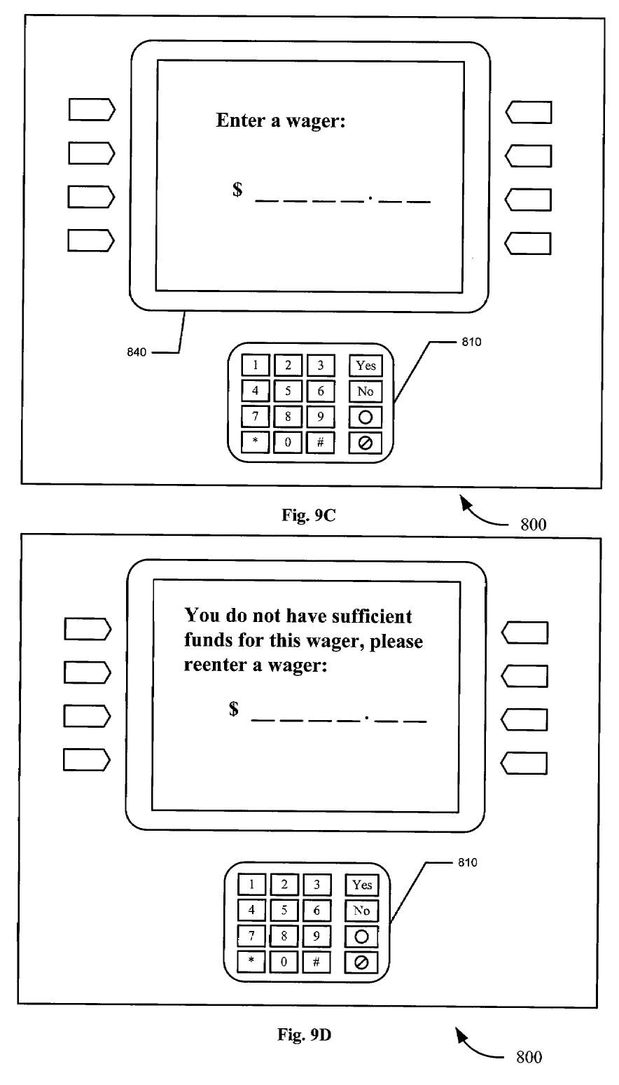

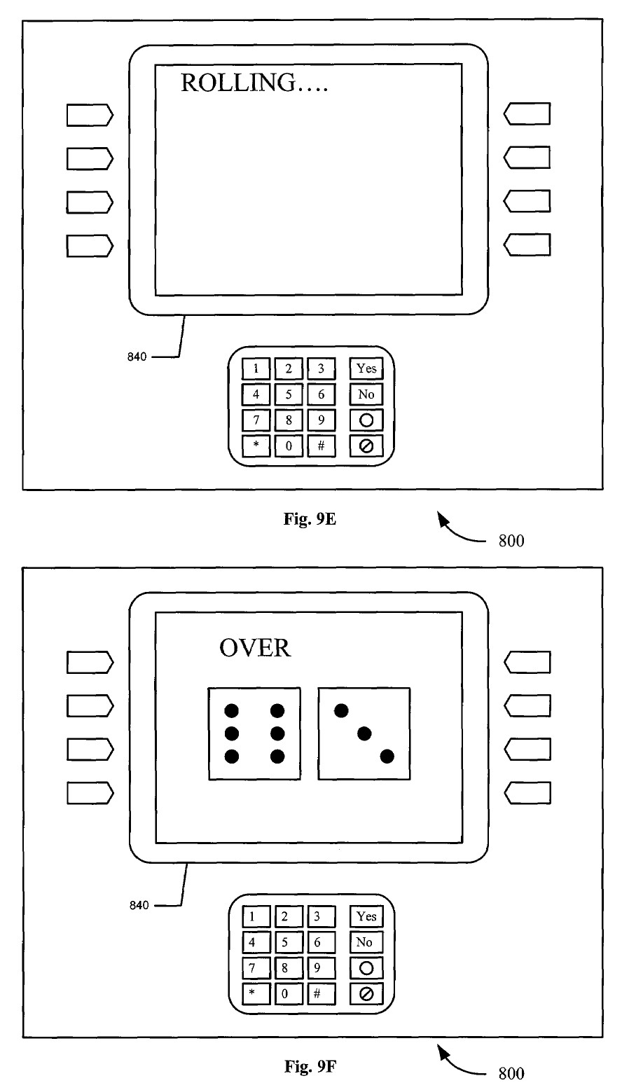

FIG. 9A shows an exemplary ATM interface 800 according to another embodiment of the invention. At the conclusion of an ATM transaction, the user is presented with a question on the screen 840 asking “Would you like to play over-under?” In some embodiments ATM cards must be registered for games of chance. Minors with ATM cards may be excluded from playing games of chance. The user may then make a selection either “YES” or “NO” by selecting the appropriate configurable button 830, 831.

The user is then asked whether a roll of the dice will result in a number that is either over or under seven as shown in FIG. 9B. The user may then make a selection either “OVER” or “UNDER” by selecting the appropriate configurable button 830, 831. In FIG. 9C the user is asked to enter a wager through the keypad 840. The wager amount appears on the screen 840. Once the wager has been entered, the system checks to determine if funds in the amount of the wager are in the user's account. If they are not, the user is informed and asked to make another wager through the keypad 810 as shown in FIG. 9D. In some embodiments, the wager is a fixed amount for each game.

The system then electronically rolls a pair of dice by initiating a random number generator that produces two random numbers between and including one and six. The screen 840 informs the user that the dice are being rolled as shown in FIG. 9E. An animation of rolling dice may be briefly shown on the screen 840. FIG. 9F shows the result of the rolled dice on the screen 810. In this example, the dice show the number nine. Accordingly, if the user selected “OVER” the user wins and is awarded the wagered amount into the users checking account. If the user selected “UNDER” the user losses and the wagered amount is removed from their account.

In other embodiments, users may be asked to select a game from a series of games to play. For example, the user may be presented with choice to chose one of a variety of games of chance, such as black jack, poker, slot games, and dice games. The user may also be presented with a choice to chose a lottery, to bet on a future event, a coupon or coupons, or other award choices. User's may also donate money to charity.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. An automatic teller machine (ATM) comprising:
a user interface adapted to receive account information from an ATM card, receive input from the user, and present information to the user;
a communications interface connected to an ATM network; and
a processor, wherein the processor comprises:
instructions to receive account information from an ATM card associated with a user;
instructions to authenticate the user for transactions with the ATM card;
instructions to complete a financial transaction between the user and a financial institution connected through the network adapter; and
instructions to present the user with a game of chance through the communications interface.

2. The system of claim 1, wherein the game of chance is a lottery and the processor further comprises:
instructions to enter the user into a lottery; and
instructions to assign a lottery number to the account associated with the ATM card.

3. The system of claim 2, wherein the processor further comprises instructions to ask the user to select a lottery number from a pool of lottery numbers.

4. The system of claim 2, wherein the processor further comprises instructions to select any lottery number.

5. The system of claim 2, further comprising memory, wherein the processor stores lottery numbers and account numbers together in a memory location within the memory.

6. An automatic teller machine (ATM) comprising:
a user interface adapted to receive account information from an ATM card, receive input from the user, and present information to the user;
a communications interface connected to an ATM network; and
a processor, wherein the processor comprises:
instructions to receive account information from an ATM card associated with a user;
instructions to authenticate the user for transactions with the ATM card;
instructions to complete a financial transaction between the user and a financial institution connected through the network adapter;
instructions to present a listing of one or more discount coupons to the user through the user interface; and
instructions to receive a selection from the user, wherein the user selects one or more discount coupons from the listing of one or more discount coupons.

7. The system of claim 6, further comprising instructions to associate the discount coupon with the ATM card, wherein the discount coupon is applied to transactions used with the ATM card.

8. The system of claim 7, wherein the discount coupon is applied to transactions at a specific location.

9. The system of claim 6, further comprising a printing device, wherein the processor comprises instructions to print the one or more discount coupons with the printer.

10. An automatic teller machine (ATM) comprising:
a user interface adapted to receive account information from an ATM card, receive input from the user, and present information to the user;
a communications interface connected to an ATM network; and
a processor, wherein the processor comprises:
instructions to receive account information from an ATM card associated with a user;
instructions to authenticate the user for transactions with the ATM card;
instructions to complete a financial transaction between the user and a financial institution connected through the network adapter; and
instructions to reward the user according to a reward program.

11. The system of claim 10, further comprising instructions to determine which reward program is associated with the ATM card.

12. The system of claim 10, further comprising instructions to look up the reward program associated with the ATM card.

13. The system of claim 10, wherein instructions to reward the user according to a reward program comprise instructions to place funds within the account associated with the ATM card.

14. The system of claim 10, further comprising instructions to determine whether the user participates in a reward program.

15. The system of claim 10, wherein the reward program is selected from the group consisting of a travel reward, money, and points for a shopping program.

16. An automatic teller machine (ATM) comprising:
a user interface adapted to receive account information from an ATM card, receive input from the user, and present information to the user;
a communications interface connected to an ATM network; and
a processor, wherein the processor comprises:
instructions to receive account information from an ATM card associated with a user;
instructions to authenticate the user for transactions with the ATM card;
instructions to complete a financial transaction between the user and a financial institution connected through the network adapter;
instructions to query the user for a wager amount in a game;
instructions to play the game;
if the user loses the wager, instructions to remove the wager amount from the account associated with the ATM card; and
if the user wins the wager, instructions to place the wager amount in the account associated with the ATM card.

17. The ATM of claim 16, wherein the game is selected from the group consisting of electronic blackjack, electronic over-under game, electronic dice, electronic craps, and sports betting.

18. A method for providing a lottery feature to a user at an ATM comprising:
receiving an ATM card from a user;
authenticating the user for transactions with the ATM card;
completing a financial transaction between the user and a financial institution connected through the network adapter;
querying the user to select a lottery number from a pool of lottery numbers, wherein the user selects a first lottery number through the user interface; and
assigning the first lottery number to the card.

19. A method for providing coupons to a user at an ATM comprising:
receiving an ATM card from a user;
authenticating the user for transactions with the ATM card;
completing a financial transaction between the user and a financial institution connected through the network adapter;
presenting a listing of one or more discount coupons to the user through the user interface; and
receiving a selection from the user, wherein the user selects one or more discount coupons from the listing of one or more discount coupons.

20. A method for providing rewards to a user at an ATM comprising:
receiving an ATM card from a user;
authenticating the user for transactions with the ATM card;
completing a financial transaction between the user and a financial institution connected through the network adapter;
rewarding the user according to a reward program.

21. A method for providing a game to a user at an ATM comprising:
receiving an ATM card from a user;
authenticating the user for transactions with the ATM card;
completing a financial transaction between the user and a financial institution connected through the network adapter;
querying the user for a wager amount in a game;
playing the game;
if the user loses the wager, removing the wager amount from the account associated with the ATM card; and
if the user wins the wager, placing the wager amount in the account associated with the ATM card.
